(19) United States
(12) Patent Application Publication
(10) Pub. No.: US 2002/0138304 A1
(43) Pub. Date: Sep. 26, 2002

(54) Method for the cost-effective delivery of medical services pursuant to a procedure-based manual

(76) Inventor: James Fontanesi, Clinton Township, MI (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/068,109

(22) Filed: Feb. 5, 2002

Related U.S. Application Data
(63) Continuation of application No. 08/941,872, filed on Sep. 30, 1997, now abandoned.
Application No. 08/941,872 is a continuation of application No. 08/394,141, filed on Feb. 24, 1995, now abandoned.

(51) Int. Cl. G06F 17/60

(52) U.S. Cl. 705/2; 705/3

(57) ABSTRACT

A method and a health care system utilizing the method for providing treatment to a patient including healthcare services which includes obtaining and recording data from the patient relating to background data, such as demographics, insurance information and medical history; staging and diagnosing the patient's ailment; obtaining and recording data relating to the patient's quality of life and economics; obtaining a range of preferred treatments based upon the staging, quality of life and economic data; and providing treatment to the patient. After treatment, second quality of life and economic data are obtained, recorded, and utilized to amend the range of preferred treatments to maximize the second quality of life and economic factors. In an alternative embodiment, the method and system include means for timing the delivery of treatment and for conditioning payment to the healthcare provider upon completion of the treatment within prescribed time periods.

### BACKGROUND OF THE INVENTION

1. Field of the Invention

The present invention relates generally to a system and a method for analysis of the physical outcomes of the treatment of a patient and the relationship of economic and quality of life endpoints with respect thereto. More particularly, the present invention identifies a range of treatments which fall within a national “standard of care” that physicians will utilize in making treatment decisions which have been established by a scientific advisory board comprised of experts in the appropriate field for the specific procedure. More particularly the present invention redefines utilization review and review of quality assurance issues using a method that allows for analysis of the quality of the results of a specific treatment, based upon quality of life and economic data, as related to the costs of a range of varying treatments to determine if present cost structures based on a previous notion of reimbursement per unit activity can be reduced while maintaining improved quality, treatment outcomes, and quality of life and economic endpoints which are either the same or improved when compared to historical controls. Additionally, the present invention relates to a system which achieves the above while implementing controls over the timing of the delivery of treatment.

2. Description of the Prior Art

Prior to the present invention it has been necessary for physicians to process a wide variety of papers and forms to receive compensation for their services and to identify various treatments which are considered efficacious. However, there has been little utilization of the quality of life and economic endpoints as related to treatment outcomes in an effort to determine if the cost of a procedure is efficacious as it relates to the numerous potential services which may be provided by the treating physician. In the past, physicians have submitted claims based on utilization review and quality assurance checks for services which were rendered without being able to detail through the payor services whether or not the physicians rendering a particular service have made any improvement in the patient's outcomes when related to other physicians treating the same disease entity. Traditionally, forms submitted are usually paper or electronic transfers for both data and charges for services.

Medical billing systems and methods are plentiful and well known. For example, U.S. Pat. No. 5,325,293, to Dome, discloses a system and method for correlating medical procedures and medical billing codes. In particular, Dome discloses a system which correlates billing codes under the Current Procedural Terminology (CPT) coding system as structured by the American Medical Association for Medicare patients, into a new billing code which does not require a thorough understanding of the nomenclature used by the CPT coding system. Thus, Dome teaches a system and a method for correlating medical procedures into billing codes, such as CPT codes which allows a physician to maximize the procedures billed.

U.S. Pat. No. 4,858,121, to Barber et al. discloses a medical payment system which a physician may utilize to file electronic insurance claims. Barber et al. disclose and teach a computerized system used solely for expediting the processing of medical claims and bills utilizing computers located in the physicians' offices which are connected via modem to a central processing computer for verification and billing and a means for electronically transferring funds collected from the insurance carrier directly to the physician's bank account.

U.S. Pat. No. 5,301,105, to Cummings, Jr., discloses a fully integrated health care system which provides for the integrated interconnection and interaction of the patient, health care provider, financial institution, insurance company, utilization reviewer and employer. Cummings, Jr. teaches that the disclosed system provides patients with complete and comprehensive treatment with predetermined financial support therefor.

Cummings, Jr., teaches that the disclosed integrated system improves efficiency thereby reducing costs. Cummings, Jr. teaches that costs are reduced by enforcing “health wellness” principles and by integrating preventive medical programs with treatment programs. Additionally, the '105 patent discloses that the integrated system includes utilization review customized according to predetermined criteria including both concurrent and retrospective utilization review. The Cummings, Jr., patent teaches that the system includes comprehensive preventive health measures, the review of the necessity for implementing selected procedures including changes in life styles, obtaining second opinions, and optimization of health-inducing diet and life style factors.

### SUMMARY OF THE INVENTION

The present invention relates to a method for providing a fully-integrated health organization system which includes patient data, utilization review, quality assurance, quality of improvement, and the acquisition of quality of life and economic data including a standard format and critical pathway of care which provides for reference costs to be set and reassessed based upon the quality or desirability of the outcome of the treatment considering the patient's quality of life and economic improvement. The present invention also provides for the availability of physician and facility evaluations regarding the outcome of treatment in reference to other facilities and physicians. Finally, the method of the present invention incorporates a status check to ensure the timeliness of providing of treatment by refusing reimbursement to the health care provider or treating physician for the failure to timely render treatment.

The present invention herein avoids the submission of forms for individual treatment regimens and instead allows for treatment selection based upon a Procedure-Based Manual (PBM) system. Reimbursement to the provider for services is based solely upon completion of therapy and determination and recording of quality of life and economic endpoints as required within the Procedure-Based Manual system. The present invention further provides for a system wherein the PBM code is standardized, without changes noted for geographical location, thereby ensuring a national standard of treatment. The PBM system is designed to determine a range of treatments which are most efficacious for a particular diagnosis to maximize an individual's resulting quality of life and economic potential.

The present invention also allows for flexibility in determining any necessary changes and departures from the range of treatments recommended by the Procedure-Based Manual system. The ability to depart from the recommended range of treatments eliminates the need for an insurance company/payor to review separate forms for various services rendered since all that is required for reimbursement is completion of the therapy pursuant to the treatment recommended by the PBM including the acquisition of quality of life and economic endpoints which are to be received at a central processing center.

Once the health care provider obtains the quality of life and economic data and transmits this information to the central processing center, the present invention further provides for a Scientific Advisory Board (SAB) (preferably a panel of nationally and internationally-known academicians who practice at both universities and community hospitals) to determine whether the treatments which have been utilized most frequently result in improved or similar local control rates when compared to previously-noted historic trails and whether these control rates have any impact on the economics and quality of life of an individual patient or an entire group of patients. Additionally, the present invention allows for investigational questions to be asked in a systematic fashion allowing analysis of treatment outcomes when compared to standard therapy and will directly relate to economic and quality of life endpoints.

Following periodic review of a PBM, the SAB has different options available for implementing changes to the PBM. They can determine whether any changes need to be made based on whether or not any costs can be reduced, and/or increased if information is available that details that the quality of life and economic endpoints as they relate to the physical parameters and outcomes of therapy have been improved when compared to historical parameters. It may also be determined from the investigational PBM that new therapies, although more costly, do represent improved physical quality of life and/or economic outcomes and thus should be included in the updated standard of care PBM.

The present invention further includes a payment system which is based upon a single cost broken down into two parts: one cost based on the physical delivery of treatment and a second cost based on the collection of economic and quality of life endpoint data. This system will provide better analysis of the outcome of treatment as related to quality of life and economic endpoints and allow the provider to make decisions based upon these reviews in a way which has not previously been capable.

One of the general objectives of this invention is to provide a fully-integrated health organization system which utilizes patient data, utilization review, quality assurance, quality of improvement, quality of life data and a standard format and critical pathway of care which allows for reference costs to be assessed and readdressed based on treatment outcomes and will also provide the availability of physician and facility evaluations regarding the outcome of treatment in reference to other facilities and physicians.

It is a further object of the present invention to provide an integrated health care management system for various health services, (i.e. radiation oncology, wound care) that allows for interactive participation between patients, providers, and payors.

It is an object of the present invention to obtain patient data, including standard age, sex, hormonal, and socio-economic data in addition to economic and quality of life data, which will include data from family members and employers.

It is an object of the present invention to utilize the International classification of disease (ICD) codes which are an internationally-recognized system for identifying disease sites.

It is a further object of the present invention to utilize internationally-accepted staging systems such as the American Joint Cancer Commission (AJCC) or International Union of Cancer Commission (IUCC) or other accepted staging systems.

It is further object of the present invention to cross-link the ICD-based codes with the AJCC/IUCC or other staging systems which will then produce an entry code for the base of the Procedure-Based Manual (PBM) system.

It is another object of the present invention to utilize a Procedure-Based Manual (PBM) as a numerically based code which will allow for access into the remainder of the system.

It is a further object of the present invention to utilize bibliographical information based upon scientifically peer-reviewed data, which will provide reason for the described treatment regimens identified within a particular PBM code.

It is a further object of the present invention to establish the minimum extent of the basic staging of a disease required prior to initiation of therapy based on the PBM codes.

It is a further object of the present invention to ensure that informed consent is obtained prior to initiation of any treatment, wherein the informed consent details the treatment regimens which will be utilized so that patients are under complete notification of expected benefits and possible complications of a treatment.

It is another object of the present invention to have a range of treatments for each PBM which is based upon the recommendations of a scientific advisory board.

It is another object of the present invention to have physical data quantification of therapy which is recorded to be utilized for future evaluation.

It is another object of the present invention to establish dosimetric data, where applicable, which is required based upon the physical requirements utilized in the PBM treatment range to be recorded for future evaluation.

It is another object of the present invention to evaluate treatment outcomes based not only on response to therapy, but also on the basis of economic and quality of life outcomes.

It is a further object of the present invention to utilize the quality of life and economic data.

It is a further object of the present invention to establish minimum requirements during a post-therapy time frame for reviewing quality of life data and economic data and to link such data to response to treatment data.

It is another object of the present invention to have all information including treatment data, quality of life data, economic data, and patient profile data, to be processed at a central processing system, which will allow for detailed evaluation of outcomes as related to the results of therapy and to the quality of life and economic data.

It is another object of the present invention to establish and monitor a treatment schedule for each individual treatment plan within each PBM to be utilized by a treating physician.

It is an object of the present invention to access quality of life and economic data endpoints at the initiation, during, and after treatment to develop a measurement of outcome based upon treatment efficacy, economic efficacy, and social efficacy such as dental, auditory, nutritional and related laboratory studies, to determine the efficacy of utilization of ancillary services.

It is a further object of the present invention to furnish a treatment physician and payor notice of default when treatment is not finished in compliance with a scheduled time for treatments within an individual treatment plan selected from the PBM.

It is a further object of a present invention to allow for utilization review which will allow for variances which are reviewed by an independent party as to acceptability outside the range of the PBM.

It is an object of the present invention to provide for a utilization review to take place on a two-tier system which allows for multiple opportunities to have independent reviewers determine acceptability of treatment plans not within the PBM system.

It is a further object of the present invention to allow for treatment according to the above objects for individuals on either an in-patient or an out-patient basis.

It is another object of the present invention to provide a system flexible enough to maintain a fluid state of evaluation such that on-line, real-time evaluation of data is possible.

It is further object of the present invention to have a fixed fee for services based on a given PBM code. Payment to the treating physician or health care provider will be conditional upon both delivery of treatment and acquisition and recordation of quality of life and economic data endpoints according to the PBM.

It is a further object of the present invention to provide for the review of treatment outcomes including quality of life and economic data to allow a scientific advisory board, payors and providers, to determine if treatment efficacy can help to reduce or cause an increase in costs based upon desirable changes in outcome.

It is also an object of the present invention to establish an accreditation procedure by which any participating health care provider can be trained to utilize the method of the present invention.

It is a further object of the present invention to provide an electronic system for implementing the method of the present invention.

It is a further object of the present invention to utilize conventional credit-type cards for use within the system according to the present invention.

The foregoing and other objects and features of the present invention will be apparent from the following detailed description of the preferred embodiment with reference to the drawings.

### BRIEF DESCRIPTION OF THE DRAWINGS

FIGS. 1A and 1B are a block diagram illustrating the basic principal functional elements of a Procedure-Based Manual system according to the present invention;

FIG. 2 is a block diagram illustrating an expanded patient entry data input/patient authorization process;

FIGS. 3A and 3B are a block diagram illustrating the reporting loop of data from a health provider's personal computer at a health facility to a central processing system;

FIGS. 4A and 4B are a block diagram illustrating a utilization review and a time default system process according to the present invention;

FIGS. 5A and 5B are a block diagram illustrating expanded utilization review and a treatment completion notification process according to the present invention;

FIGS. 6A and 6B are a block diagram illustrating an investigational PBM process according to the present invention; and

FIGS. 7A and 7B are a block diagram illustrating data review and reporting according to the present invention.

### DETAILED DESCRIPTION OF THE PREFERRED EMBODIMENT

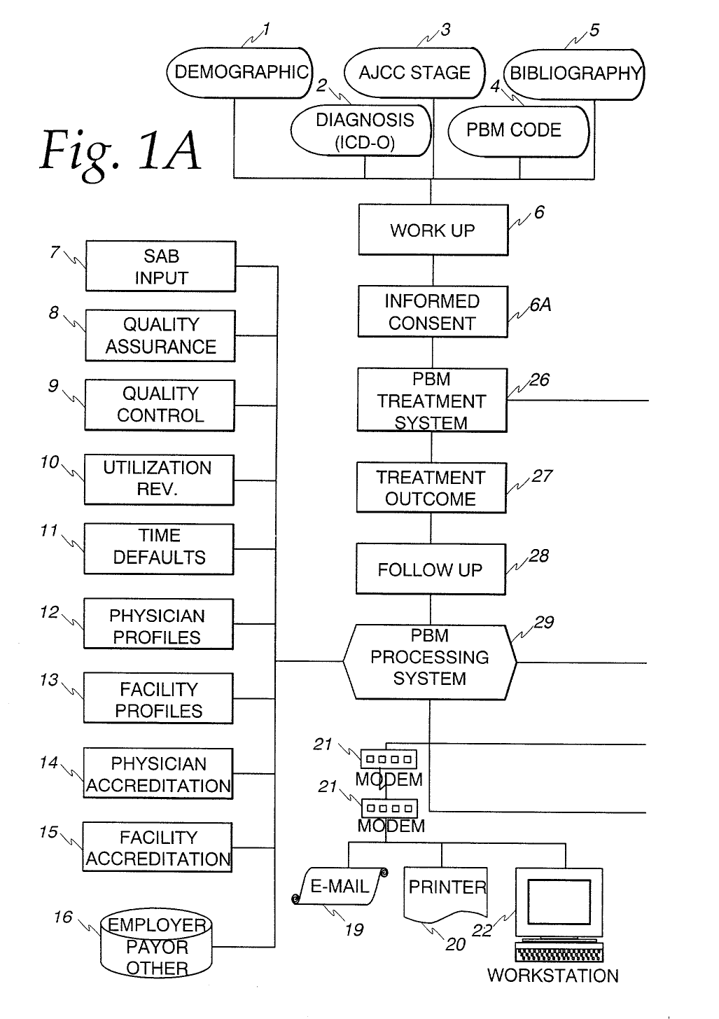

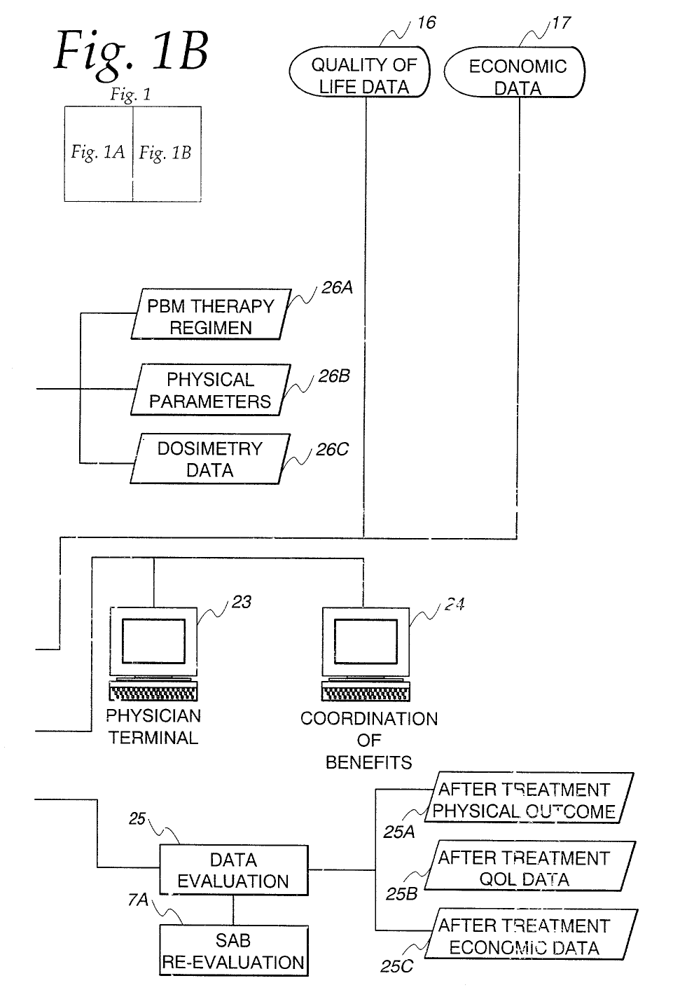

Now turning to the drawings and in particular to FIGS. 1A and 1B, it will be observed that the following information is based upon the basic design of a Procedure Based Manual (PBM) Treatment System 26. The PBM 26 is essentially a collection of numerous procedures for treating different ailments as diagnosed by a healthcare provider or treating physician. The PBM 26 contains a plurality of recommended procedures for a given ailment depending upon the particular status of the ailment and the ratings of the symptoms, as described in detail below.

The method of the present invention is utilized for providing treatment for administrating health care facilities by utilizing a system which will significantly increase the quality of health care provided to individuals while reducing the overall cost.

The method of the present invention is preferably implemented using a computer system, however, it is possible to utilize a manual system or to utilize a partially manual and partially computerized system. Preferably, the computer system includes a first computer or physician terminal 23 located at the healthcare provider or treating physician's facility and a central (PBM) processing system 29 located at a main processing center. The treating physician uses the computer to record data obtained during the treatment of the patient and then transmits the information to the main processing center using any known electronic means such as by modem 21 or E-mail 19 and as further explained below.

Prior to administering treatment to the patient, it is necessary for the healthcare provider or treating physician to do an initial patient data profiling or workup 6. Additionally, prior to providing any treatment, the physician will ensure that the patient is completely informed of what procedures will be performed and the patient's informed consent is obtained 6A.

During the profiling, the treating physician obtains demographic information 1 from the patient including, but not limited to, age, sex, race, place of residence, place of birth, family history regarding similar ailments (such as malignancy, in the case of cancer) or other important data regarding possibly genetically-transmitted diseases. The treating physician will also obtain information regarding utilization by the patient of tobacco products, alcohol, or presently-illegal drugs, along with the functional status of the patient. Additionally, the workup will preferably include obtaining information regarding hormonal manipulation or usage, menopausal status, as appropriate, previous diagnosis and therapies, present medical utilization, including prescription drugs and other information which will help to develop a fully-integrated patient profile.

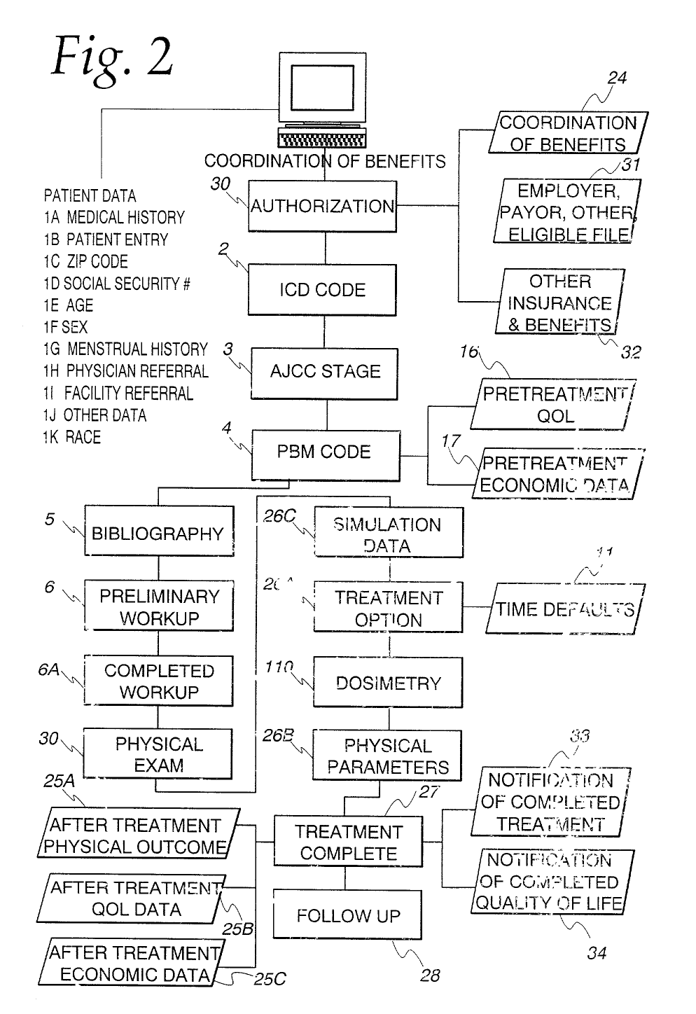

Once the physician has obtained the above information through patient profiling 6, the information is recorded in the physician's terminal 23 and authorization 30, see FIG. 2, is obtained to continue treatment. The method for obtaining authorization 30 depends upon the type of medical insurance covering the patient. Typically, there is either a coordination of benefits 24, an employer or third party payor eligible file 31 or some other insurance and benefit program 32, which is available to the patient. This information is also preferably obtained during the initial interview or screening process and recorded in the treating physician's terminal 23 located within the treating facility.

The treating physician or healthcare provider first, preferably examines the patient and assigns standardized codes to describe the status of the patient's ailment. It is preferable to first determine the status of the ailment in terms of classification and staging; however, it is possible to first assign a PBM code to the particular ailment and then conduct the status check of the ailment. However, in the present preferred embodiment, the ailment is first classified, staged and then the PBM code is assigned, as described below.

The status is typically characterized using an international classification of disease (ICD) code 2 and a standardized staging code 3, see FIGS. 1A and 1B. Once the treating physician determines the classification of the ailment utilizing the accepted standard, the classification is recorded within the physician's terminal located in the physician's office. Preferably, in the area of oncology, such a classification code would be assigned utilizing the International Classification of Diseases for Oncology, 2d Edition (1990), from the World Health Organization in Geneva, Switzerland. However, the PBM will provide the physician with a list of different authoritative references to utilize in classifying the ailment.

As described above, preferably, the patient is next assigned a standardized staging code 3 to further identify the progression of the ailment. The physician is provided with a description of the basic minimum staging required prior to initiation of treatment. The staging 3 information is completed upon a worksheet, similar to the classification 2 information. Again, the staging code utilized depends upon the particular ailment being staged for the patient. Similar to the classification code 2, the physician or health care provider will again be provided with a list of authoritative references or standards which can be utilized in staging the ailment.

With respect to oncology, a patient would preferably be assigned a staging code based upon an AJCC/IUCC code or other acceptable standardized staging code. It is imperative that the ailment be classified and staged using a known standard. The physician records the ICD and staging codes into the computer. Once the classification 2 and staging 3 codes have been completed, the results are entered into the physician's terminal 23.

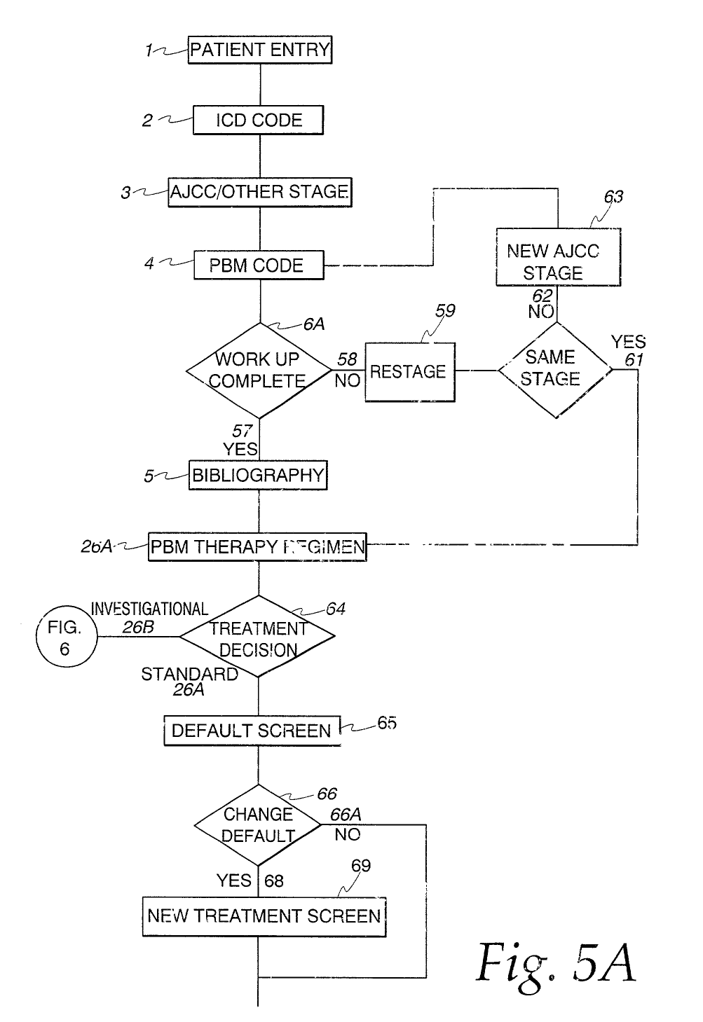

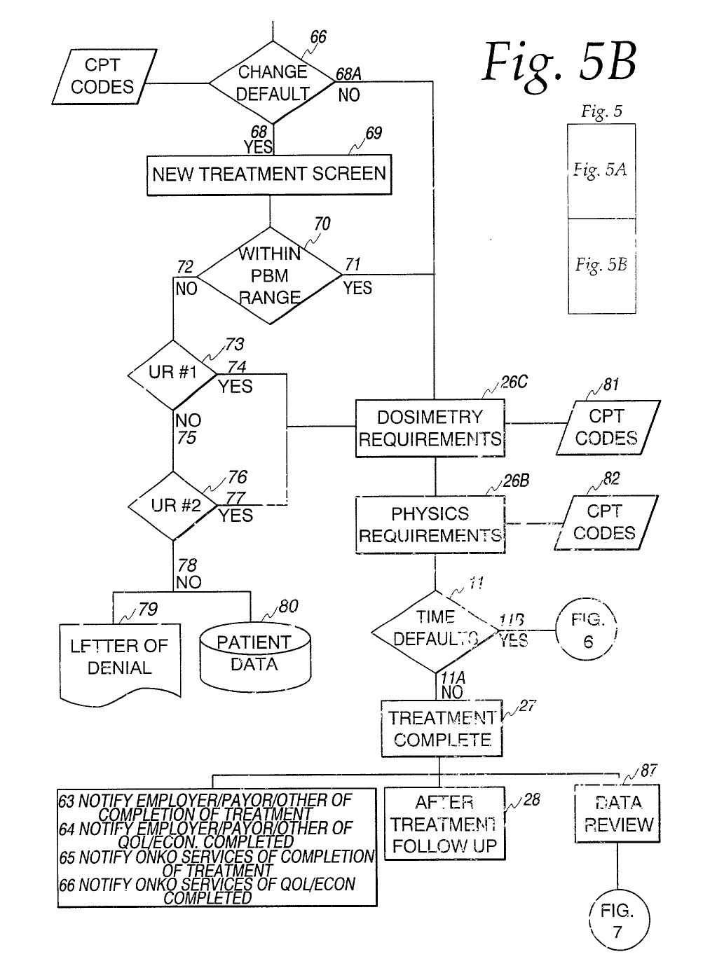

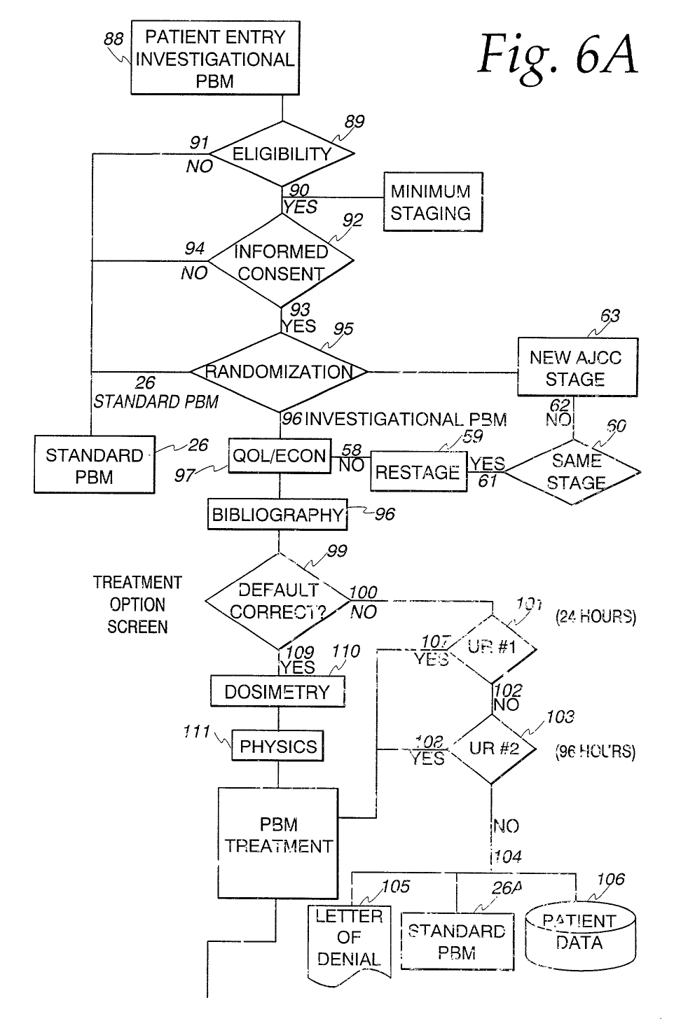

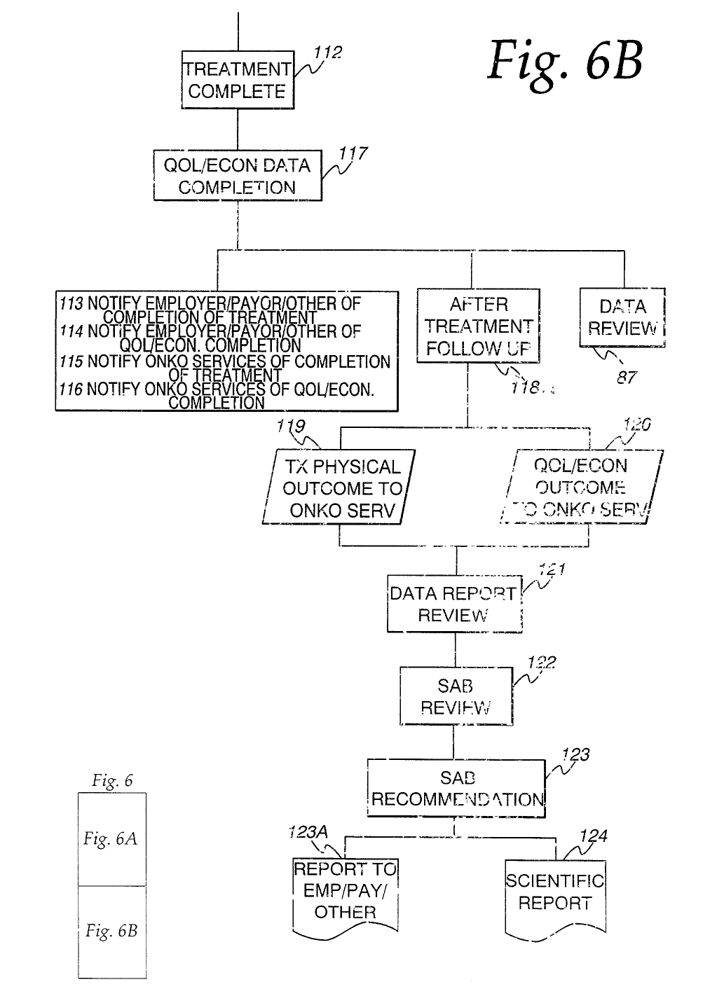

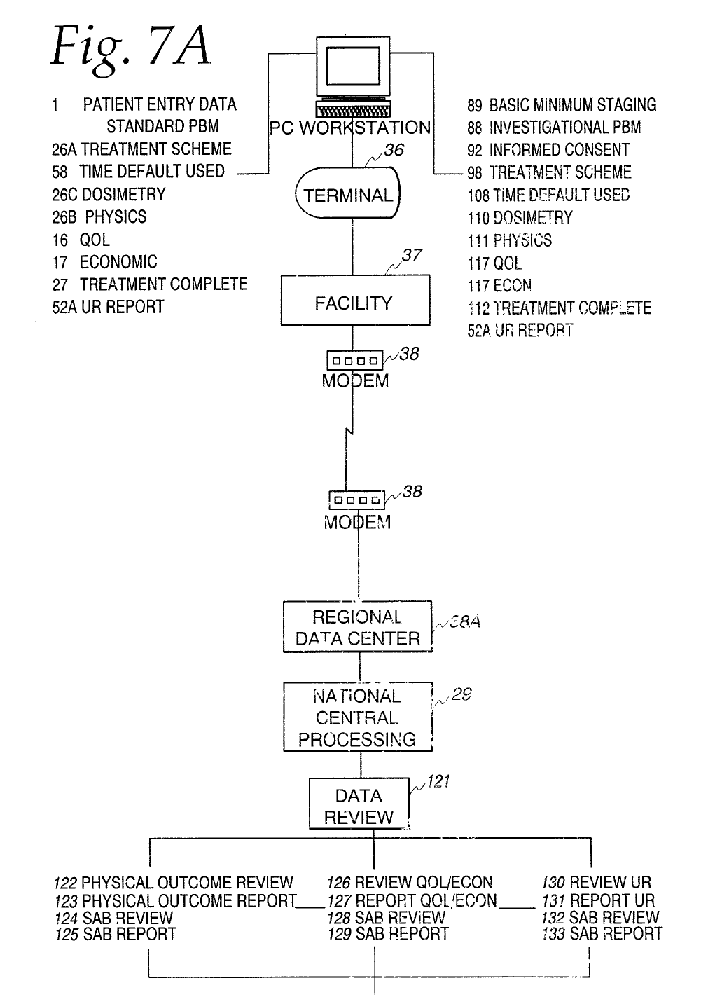

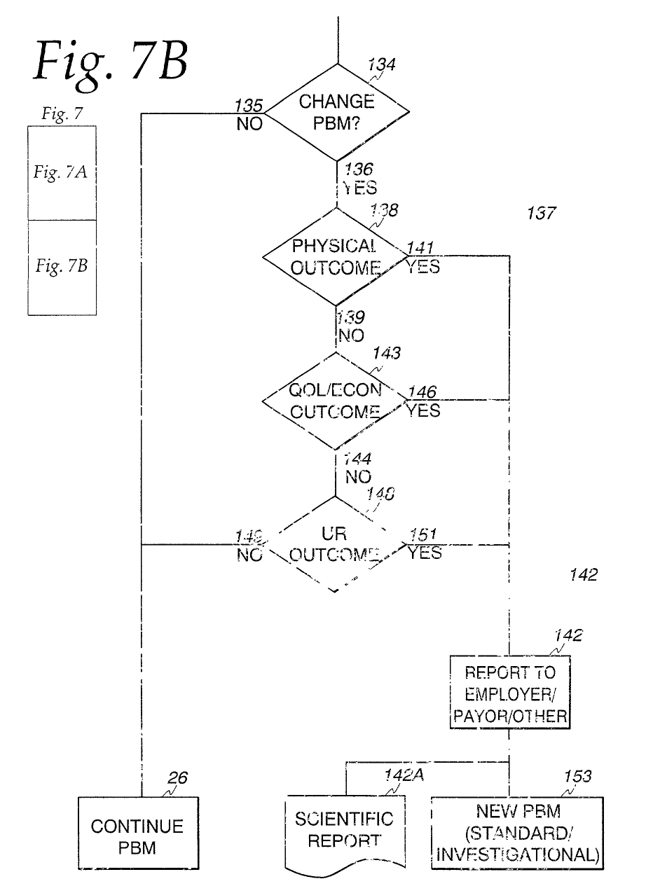

Once the PBM code has been established and the basic classification and staging has been satisfactorily completed 57, the process is continued. However, with reference to FIGS. 5A and 5B, if the workup has not been completed 58, or if there is a requirement for restaging 59, it must be completed prior to initiation of therapy. If there is a requirement for restaging 59, and the restaging 59 determines the same classification 2 and staging 3 combination 61, the patient will be returned to the PBM therapy regimen 26A so that treatment may be initiated. If there is a change 62 in the classification 2 or the staging 3, the patient is reevaluated and new information is obtained and a new PBM therapy regimen 63 is assigned based upon the new classification 2 and staging 3. The new information is recorded in the physician's terminal 23 and treatment is initiated.

In addition to the above data, pretreatment quality of life data 16 and pretreatment economic data 17 are obtained by the treating physician. The pretreatment quality of life data 16 and pretreatment economic data 17 includes, but is not limited to, measures of economic viability of the patient and acceptable quality of life standards with the possible introduction of new quality of life measures to be determined depending upon the particular ailment being treated, the particular characteristics of the patient and the possible combinations thereof. he primary object is to include pretreatment quality of life 16 and pretreatment economic factors or data 17 which are most indicative of the performance of the particular individual with respect to the particular ailment, as explained in more detail below.

The pretreatment quality of life 16 and economic data 17 are recorded in the terminal 23 within the treating physician or healthcare provider's facility utilizing a standardized system. It is preferable to utilize a system for standardizing the data which is easy for the physician to use and can be consistently used from one patient to the next and from one type of ailment to the next. In particular, it is most preferable to use a 10 base system ranking the varying degrees of answers upon either a scale of 1 to 10 or 1 to 100. The PBM includes the scale within the system and preferably presents the scale to the physician prior to obtaining the quality of life 16 and economic data 17, including an objective quantification and description of the system.

The classification 2 and staging 3 codes are then utilized to select a particular Procedure-Based Manual (PBM) therapy which matches the classification 2 and staging 3 codes. Each patient undergoing a PBM therapy is identified utilizing the demographic information 1 previously obtained to properly identify the recommended treatment for the patient. Once a particular PBM therapy regimen is selected for a particular individual, the information is indexed and recorded for the particular patient.

The PBM therapy regimen includes a range of treatments available to the treating physician to utilize in treating the patient. The PBM may have a range of dosages, types of medicines, alternative methods and varying time periods for completing different treatment regimens. At a minimum, however, the PBM will prescribe the range of treatments from which the physician or healthcare provider may choose and be completely reimbursed, without incurring review procedures, provided treatment is properly completed. The completion of treatment, includes in all cases, the acquisition of pretreatment quality of life 16 and pretreatment economic data, treatment of the patient's ailment and acquisition of after or post treatment quality of life, after or post treatment economic data and after or post treatment physical outcome data.

When the PBM therapy regimen or treatment option 26A is selected, the classification 2 and staging 3 codes are obtained and recorded by the physician and a list of bibliographic references are provided to the treating physician for reference. The physician is also now provided with detailed information with respect to the range of allowed treatments provided for within the particular PBM therapy regimen 26A. This detailed information includes the physical parameters of treatment, such as simulation data 26 for radiation patients, including the number and timing of the physical parameters 26B. Included with the particular PBM therapy regimen 26A is a default preset treatment which the physician can utilize without changes or can alternatively make changes to create different combinations of treatment within the PBM.

In addition to the physical parameters 26B, the PBM therapy regimen 26A also identifies ancillary treatment materials which will be utilized in providing treatment to the patient. For example, in the case of oncology, such ancillary treatment materials would include wedges, which help to conform radiation doses to anatomic structures, compensators, which supply a similar shaping function and other information which will help in the delivery of treatment is also identified.

The physical parameters 26B also encompass physics data 26B which is also determined and provided to the physician. The physics data 26B includes additional particulars with respect to the treatment to be provided to the patient. Such information in the preferred oncology embodiment would include a range of allowable energies of the radiation beams to be used; information regarding implantation of interstitial or intracavitary isotopes, utilization of low dose rate versus high dose rate brachy therapy, skin source distances and skin axis distances which are allowed within the PBM therapy regimen 26A. The necessary analogous information would be provided for different medical disciplines.

Once the physician selects a particular treatment within the PBM therapy regimen 26A, a time default 11 is initiated. The time default 11 is designed to ensure that the particular treatment is delivered within a particular time frame. Initially, the default time 11 is selected and approved by a review board (SAB) 7, whose other functions will be further described below. The time default 11 can be altered by the review board 7 based upon collected data and other factors. The time default is preferably set and/or altered to maximize the affects of treatment upon the patient.

Once the above is completed, treatment is provided to the patient according to the particular selected treatment. Upon completion of the therapy, a treatment completion sheet 27 is completed by the physician or healthcare provider. The treatment completion sheet 27 includes treatment completion data, including but not limited to second or after-treatment quality of life data and information 25B, second or after-treatment economic data and information and the physical outcome 25A due to the particular therapy chosen by the physician.

The treatment completion sheet 27 and its accompanying information is preferably completed as soon as possible after the completion of treatment. Additionally, the treatment completion information is recorded in the physician's terminal 23 and transmitted as soon as possible to the central processing system 29. The central processing system 29 will collect information from many physician's terminals 23 and process the information. The processed information will be made available to the review board 7 and to the payors who will be allowed to see only information relating to their patients. It is possible to have one payor share its information with another payor and between different payment groups.

As described above, the Scientific Advisory Board (SAB) or review board 7 is responsible for reviewing and evaluating treatment outcome data 7A and changes in the quality of life and economic data endpoints. The review board 7 is preferably made up of experts in various fields and, in particular, experts in the field to which the particular treatment pertains. The review board 7 thus, preferably includes nationally or internationally recognized experts in respective fields who are knowledgeable of the most advanced procedures and treatments. In an alternative embodiment, the review board 7 will also oversee quality assurance measures 8, quality control measures 9, utilization review 10, review of time defaults 11 and the impact of the above factors upon treatment outcome 25A, quality of life data 25B and economic data 25C endpoints. Additionally, the review board 7 oversees physician profiling 12 and facility profiling 13 as they relate to treatment outcome 25A and physician accreditation 14 and facility accreditation 15.

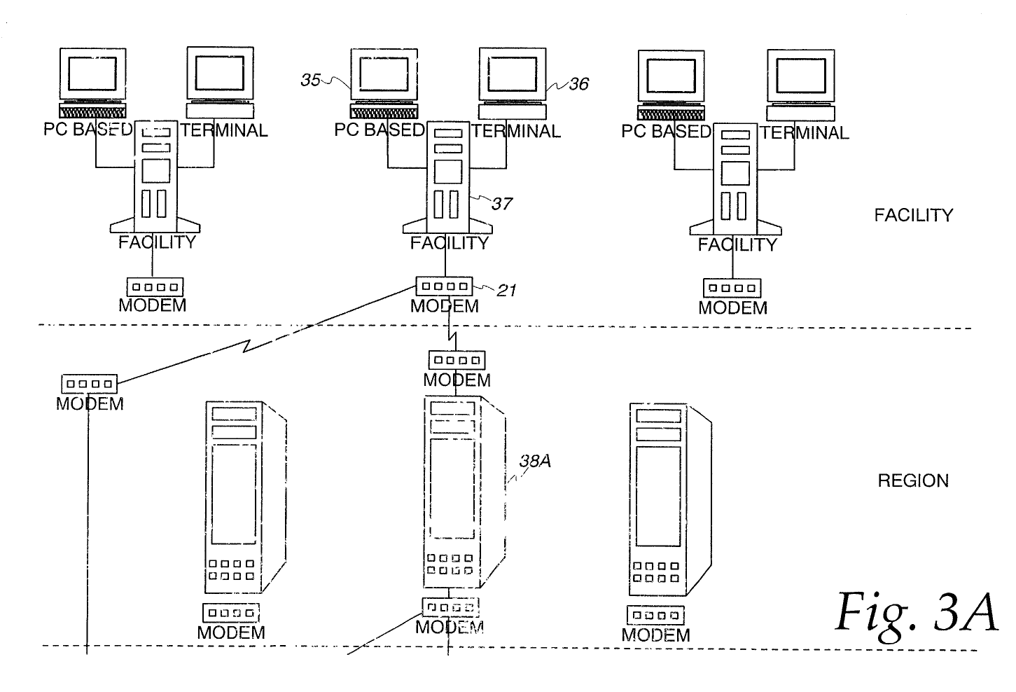

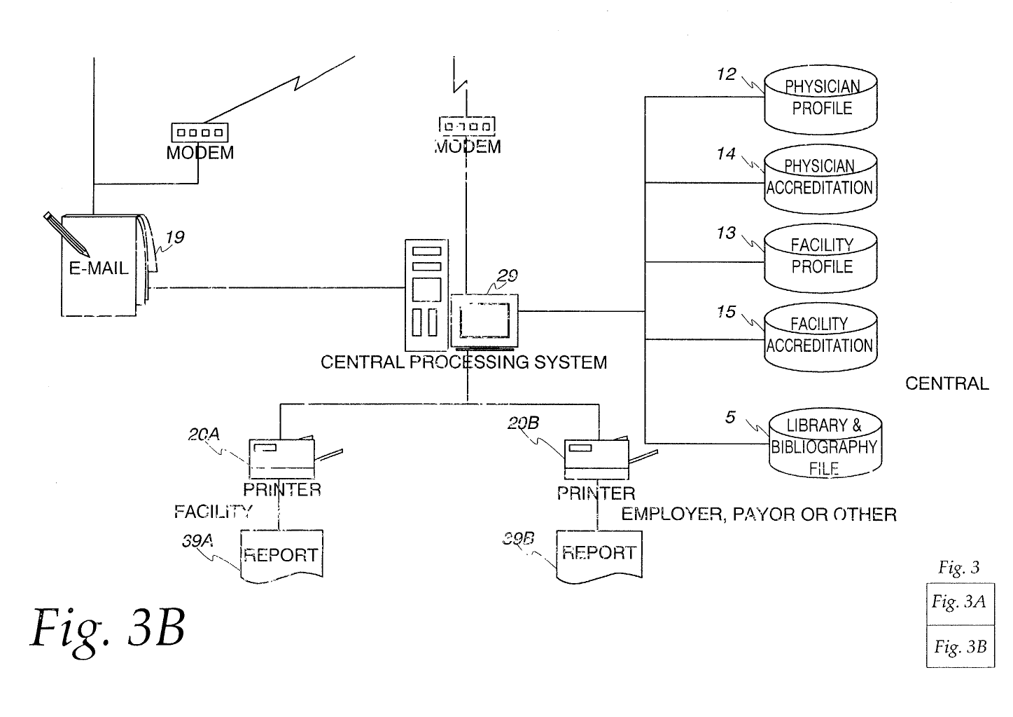

In the preferred embodiment, the method of the present invention is employed on a system utilizing computers, see FIGS. 3A and 3B. Preferably, the computers used are personal computers (due to their cost effectiveness) operating in a graphical user interface environment, such as Microsoft Windows. However, as will be understood by one skilled in the art, the present invention may be made to operate on any type of platform and any type of operating system.

A facility 37, where the treating physician or healthcare provider operates, will have a personal computer (PC) or terminal 23 running software which is customized to function with the present invention. The physician records information, as described above, obtained from the patient in the PC and transmits the information, on a regular basis, to a regional processing center 38A or directly to a central processing system 29. Thus, the information may be collected at the facility 37 for a given period of time before it is transmitted to the regional processing center 38A or to the central processing system 29. If the information is first transmitted to a regional processing center 38A, the information is collected at the regional processing center 38A for a given period of time and then transferred to the central processing system 29.

The central processing system 29 will collect and analyze the information gathered to determine which particular treatments, for a given ailment, classification and staging provide the best after treatment physical outcome 25A, quality of life 25B and economic data 25C. Additionally, the central processing system 29 will relay information between payor, employer or other benefit groups to which the patient belongs.

The central processing system 29 also functions to initiate a utilization review when a physician or healthcare provider wishes to partake in a course of treatment which is not within the range suggested in the PBM therapy regimen 26A based upon the demographic, diagnosis, classification and staging information originally recorded by the physician. When a physician decides to use a treatment not within the recommended PBM treatment regimen 26A, then the physician proposes that an investigation PBM 88 and basic minimum staging 89 be completed. If the physician meets the minimum staging requirement 90, the physician must next obtain informed consent 92 from the patient. Once informed consent is obtained 93, randomization of treatment assignment 95 is initiated. If the above requirements are not met 91 or informed consent is not obtained 94, the patient must be returned to the standard PBM process. If an investigational PBM is chosen and allowed, then the process continues with acquisition and recording of pretreatment quality of life and economic data. A bibliography relating to investigational questions 98 is made available for review by the treating physician.

Once the investigational PBM is selected and defaults have been recorded 109, dosimetric 110 and physical factors 111 relating to the delivery of therapy are made available for review and investigation. If the defaults 99 are not correct 100, a utilization review is initiated. If a first utilization review 101 has an affirmative result 107, meaning that the review board has approved the investigation PBM and the defaults 99, the patient is returned to the investigational PBM. If the first utilization review 101 has a negative result 102, then a second utilization review may be initiated. However, it should be noted that it is possible to return to the recommended PBM therapy regimen at any time, including at the end of the first utilization review.

If at the second utilization review 103 an affirmative response is given 108, the physician is allowed to continue with the investigational PBM. If a negative answer is returned 104, the physician, patient and payor group are informed 105 of the negative answer. At this point, it is possible to return to the recommended PBM therapy regimen 26A or it is possible for the patient to have treatment according to the physician's preference. However, payment to the physician will be reviewed and the actual financial responsibility will be transmitted to the payor. The actual financial responsibility information will be entered into the patient data information file 106.

Similar to the recommended PBM therapy regimen 26A, once treatment is completed 112, post-treatment quality of life and economic endpoints are recorded and transmitted to the central processing system 117. Again, notification of completion of treatment is made to the patient's employer, payor or other beneficiary group 113.

In addition to the above, utilization review will occur by the review board 7 when a time default 11 is breached, that is, when treatment is not completed within the time default 11, regardless of whether the treatment is or is not according to the recommended PBM therapy regimen 26A. The review board 7 will investigate to find the reason for the default 54 and/or to warn the facility and physician of potential default. The basis for the default 54 and the review board's 7 determination will be recorded 55 into the patient data 56. As previously stated, this information will be related back to quality of life data 16, economic endpoints 17 and physical outcomes of treatment 25A.

The central processing system 29, in an alternative embodiment, can act to relay information between the carrier company and the patient's payor, employer or other groups to which the patient belongs. The central processing system 29 can communicate with the employer, using any means of communication available, such as modem, E-mail, printer, etc., to notify the employer of the completion of treatment and the treatment outcome as well as economic and quality of life data.

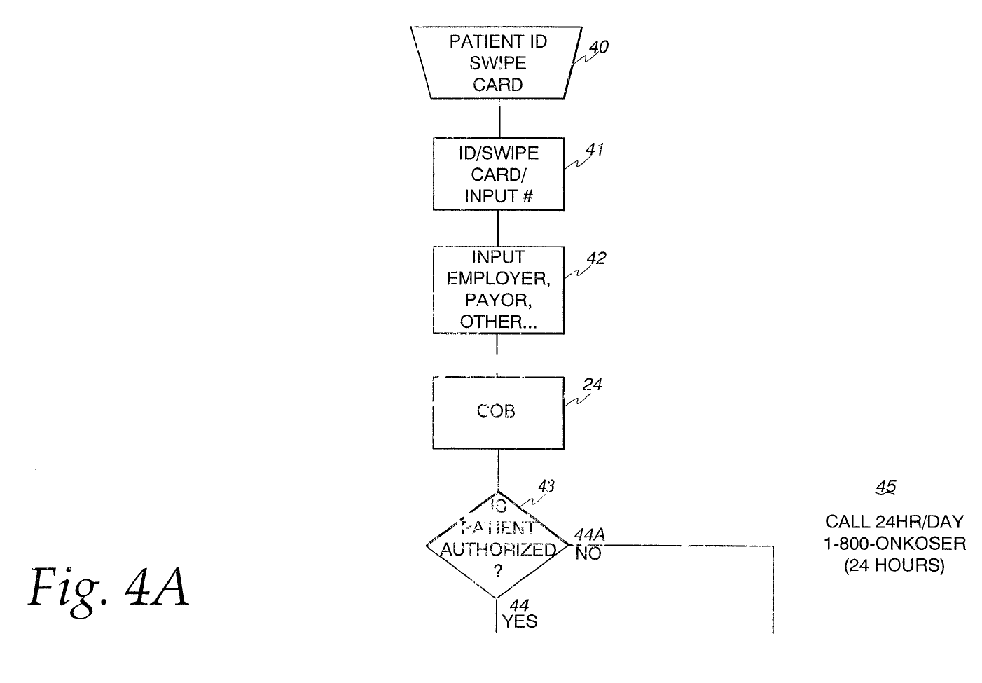

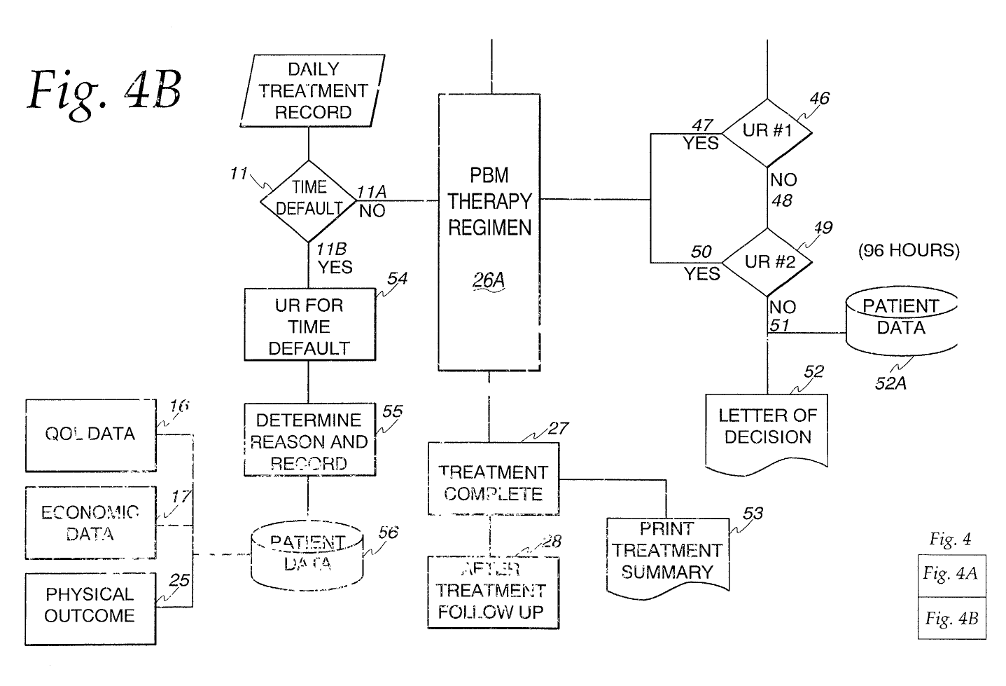

The method of the present invention is particularly suitable to implementation utilizing an electronic swipe ID card system, such as a patient ID/SMART card 40, see FIGS. 4A and 4B. The swipe card 40 has attorney is a trial attorney, his economic factor would be significantly altered. Alternatively, if the patient receiving treatment rarely utilizes his/her voice during business activities, other than for conversational activities, the impact on his/her economic factor will not be as significant.

In an alternative embodiment, it is also preferable to determine the economic impact of different treatments upon non-patient entities, such as family and friends. Typically, these factors include quantifying the effects of pain medicines, utilization of non-patient entities who miss work or other functions.

By standardizing, quantifying, recording and analyzing the quality of life and economic factors listed above, and others, it is possible to more accurately determine the overall impact that a particular therapy regimen, chosen from a group of therapies within the PBM therapy regimen, will have upon the patient in terms of both tumor regression and remission, and also how the different treatment regimens will impact the patient's ability to carry on normal day-to-day activities as well as the patient's economic viability.

Although several embodiments of the present invention have been illustrated in the accompanying drawings and described in the foregoing detailed description of the preferred embodiment, it will be understood that the invention is not limited to the embodiments disclosed, but is capable of numerous rearrangements, modifications and substitutions without departing from the scope of the invention. For example, it should be noted that the method of the present invention can be carried out by either hand or by utilizing a computer to quicken the process. It is also possible to practice the present invention utilizing a partially computerized system. Accordingly, the present invention is not to be limited to a particular way of practicing the method by hand or by electronic means, except as the claims state. Accordingly, the present invention is to be limited only by the following claims.

What is claimed is:

1. A method for providing treatment to a patient having an aliment, said method including the recordation of patient data and payment to a treating physician, said method comprising the steps of:
providing a means for recording said patient data within a treating physician's facility;
providing a central processing means located separate from said recording means;
providing a means for communicating said patient data from said facility to said central processing means;
acquiring first quality of life and economic data relating to said patient;
recording said first quality of life and economic data using said recording means;
receiving a range of treatments;
treating said patient after said step of recording said first quality of life and said economic data;
acquiring second quality of life and economic data relating to said patient after said step of treating said patient; and
adjusting said range of treatments by utilizing said quality of life and said economic data to maximize said patient's quality of life and economic conditions after treatment.

2. The method of claim 1 further comprising the steps of:
obtaining background information about said patient including demographics and a diagnosis of said patient's ailment;
classifying said patient's ailment utilizing a standardized classification system;
staging said patient's ailment utilizing a standardized staging system;
acquiring physics, dosimetry and prescription data about said patient;
recording said classification and said staging information; and
recording said physics, dosimetry and prescription information.

3. The method of claim 2 wherein said step of obtaining said background information and said step of staging said patient's ailment both occur prior to said step of acquiring said first quality of life and economic data.

4. The method of claim 1 further comprising the steps of:
obtaining a range of preferred treatments for treating said patient from a procedure based manual, said step of obtaining said range of preferred treatments occurring after said step of acquiring said first quality of life and economic data and before said step of acquiring said second quality of life and economic data.

5. The method of claim 4 wherein said step of treating said patient utilizes a treatment plan within said range of preferred treatments for treating said patient from said procedure based manual.

6. The method of claim 5 further comprising the steps of:
obtaining a time period for completing said treatment plan from said procedure based manual prior to said step of treating said patient; and
wherein said step of making payment to said physician for providing said treatment occurs only if said treatment is completed within said prescribed time period.

7. The method of claim 4 wherein said step of treating said patient utilizes a treatment plan not within said range of preferred treatments for treating said patient from said procedure based manual.

8. The method of claim 1 further comprising the step of obtaining and recording physical outcome information after said step of treating said patient.

9. The method of claim 8 further comprising the steps of:
obtaining a range of preferred treatments for treating said patient from a procedure based manual, said step of obtaining said range of preferred treatments occurring after said step of acquiring said first quality of life and economic data and before said step of acquiring said second quality of life and economic data.

10. The method of claim 9 further comprising the step of modifying said procedure based manual utilizing said first and said second quality of life and economic data and said physical outcome information to optimize the quality said second quality of life and economic data.

11. The method of claim 4 further comprising the step of obtaining and recording physical outcome information after said step of said patient.

12. The method of claim 11 further comprising the steps of:
obtaining a range of preferred treatments for treating said patient from a procedure based manual, said step of obtaining said range of preferred treatments occurring after said step of acquiring said first quality of life and economic data and before said step of acquiring said second quality of life and economic data.

13. The method of claim 12 further comprising the step of modifying said procedure based manual utilizing said first and said second quality of life and economic data and said physical outcome information to optimize the quality of said second quality of life and economic data.

14. The method of claim 7 further comprising the steps of:
submitting said treatment not within said range of preferred treatments for review by a review board;
reviewing initially said treatment not within said range or treatments; and
deciding whether to approve said treating physician's decision to utilize said treatment not within said range of preferred treatments and to make payment to said physician therefor.

15. The method of claim 14 further comprising the step of providing a secondary review procedure for reviewing said step of deciding whether to approve said treatment not within said range.

16. A system for providing healthcare to a patient undergoing a treatment selected from a range of treatments, comprising:
a local processing means for recording patient data within a treating physician's facility;
a central processing means located separate from said local processing means;
means for communicating said patient data from said local processing means to said central processing means;
means for recording first quality of life and economic data relating to said patient;
means for recording second quality of life and economic data relating to said patient; and
means for reviewing said first and second quality of life and economic data and adjusting said range of treatments by utilizing said first and second quality of life and said economic data to maximize said patient's quality of life and economic conditions after treatment.

17. The system of claim 16 further comprising:
means for recording physics, dosimetry and prescription information relating to said patient;
means for recording ailment staging information; and
means for recording ailment classification information.

18. The system of claim 17 further comprising a procedure based manual for providing a range of preferred treatments for treating said patient.

19. The system of claim 18 further comprising means for determining whether said treatment from said procedure based manual has been completed within a predetermined amount of time.

20. The method of claim 1 further comprising the step of making payment to said physician for providing treatment upon completion of said first and said second steps of acquiring said quality of life and economic data.
